(19) United States
(12) Patent Application Publication
(10) Pub. No.: US 2012/0123949 A1
(43) Pub. Date: May 17, 2012

(54) METHOD AND SYSTEM TO AUTOMATICALLY MODIFY TASK STATUS IN A PROJECT MANAGEMENT SYSTEM VIA KEYWORDS IN SOURCE CODE VERSION CONTROL COMMIT LOGS

(76) Inventor: Shreyank Gupta, Magarpatta City (IN)

(21) Appl. No.: 12/948,113

(22) Filed: Nov. 17, 2010

(51) Int. Cl. G06Q 10/00

(52) U.S. Cl. 705/301

(57) ABSTRACT

A server maintains a project management data store. The project management data store comprises tasks of a project and corresponding current task status data for the tasks. The server obtains a commit log from a source code revision control system, wherein the commit log comprises new task status data for at least one task of the project. The server locates at least one keyword in the commit log to identify a change in status of at least one task and updates the current task status data in the project management data store to reflect the change in the status of the at least one task.

### TECHNICAL FIELD

Embodiments of the present invention relate to project management. Specifically, the embodiments of the present invention relate to automatically modifying task status in a project management system via keywords in source code version control commit logs.

### BACKGROUND

Users, such as software developers, write and modify source code to develop software programs. The software development is typically managed as a project by a project management tool. The implementation of any changes made to the source code is typically tracked by a source code revision control tool (also known as source code version control tool). Some examples of a project management tool for managing and tracking a software project are Trac and Basecamp®. Some examples of a source code revision control tool for managing the development of computer software are CVS (Concurrent Versions System), Subversion® (SVN), GIT, and Mercurial. A user can work on one or more software projects, and a software project can have one or more team members.

A project management tool uses a tasking system, where the work on a specific project is divided into one or many atomic tasks. A project can have any number of tasks, which can be currently assigned or not yet assigned to a project member. A task can have one of many states, such as ‘New’ (unassigned), ‘Opened’ (assigned), ‘Stalled’, ‘Closed/Resolved’. The project management tool stores and maintains the current status of each task for a project.

Project members continuously revise and update source code. When a user is ready to implement a source code revision, the user inputs a new revision into the source code revision control tool, and the source code revision control tool performs a commit operation. A ‘commit’ and/or ‘committing changes’ is a process by which a user records changes to the software source code. When committing a change, a user generally specifies a commit log to record data about the change. A commit log may include task identifiers and new task status data for the tasks.

However, typically, even though the changes are committed in a source code revision control tool, the new task status data in a commit log is not reflected in a project management tool until a user manually changes the task statuses for the project in the project management tool. Generally, a user can view a commit log from a project management tool and see what has changed, but then needs to manually change the task statuses in the project management tool. Until this manual process is performed, the task status data in the source code revision control tool and the task status data in the project management tool may not be in sync. Thus, the task status data in the project management tool is not always up to date and reliable.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is an exemplary network architecture in which embodiments of the present invention may operate.

FIG. 2 is a block diagram of one embodiment of an automated task updater subsystem.

FIG. 3 is a flow diagram of an embodiment of a method for automatically modifying task status in a project management system via keywords in source code revision control commit logs.

FIG. 4 is a diagram of one embodiment of a computer system for automatically modifying task status in a project management system via keywords in source code revision control commit logs.

### DETAILED DESCRIPTION

Embodiments of the invention are directed to a method and system for automatically modifying task status in a project management system via keywords in source code revision control commit logs. A server maintains a project management data store. The project management data store comprises tasks of a project and corresponding current task status data for the tasks. The server obtains a commit log from a source code revision control system, wherein the commit log comprises new task status data for at least one task of the project. The server locates at least one keyword in the commit log to identify a change in status of at least one task and updates the current task status data in the project management data store to reflect the change in the status of the at least one task.

‘Source code version control’ is also referred to as ‘source code revision control’. Typically, whenever a source code revision control system performs a commit, a user has to manually change the task statuses in the project management data for the project. Until this manual process is performed, the task status data in the source code revision control system and the task status data in the project management system may not be in sync. Embodiments of the present invention provide a system to automate this manual process. Users can use a source code revision control system to commit source code changes and embodiments of the invention automatically can update the task status in a project management system via keywords in the source code revision control commit logs to provide more reliable data in the project management tool.

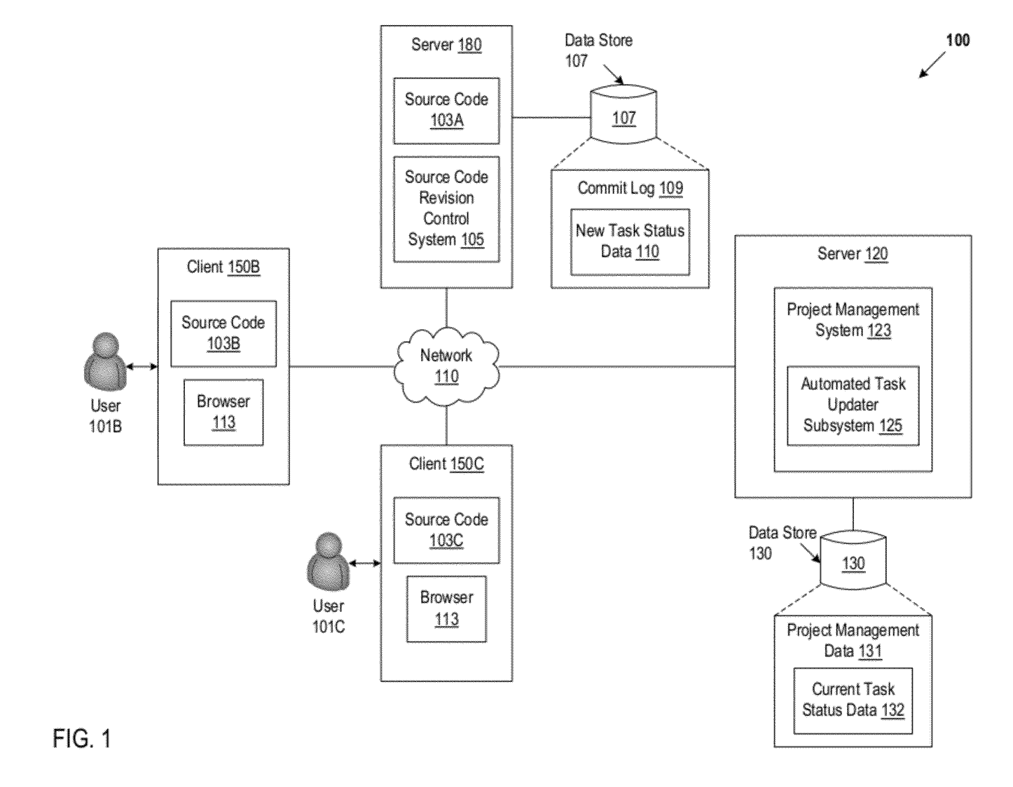

FIG. 1 is an exemplary network architecture 100 in which embodiments of the present invention can be implemented. Embodiments of the invention are directed to a method and system for automatically modifying task status in a project management system via keywords in source code revision control commit logs. The network architecture 100 can include client machines 150 communicating with servers 120,180 via a network 110. The network 110 can be a local area network (LAN), such as an intranet within a company, a wireless network, a mobile communications network, a wide area network (WAN), such as the Internet or similar communication system. The network 110 can include any number of networking and computing devices such as wired and wireless devices. The client machines 150 can be any type of computing device including desktop computers, laptop computers, mobile communications devices, cell phones, smart phones, hand-held computers, or similar computing device.

One or more users 101B,C, such as a project manager and project team member (e.g, software developer) can work on one or more projects, such as a project to write/modify source code 103A for software. A software project is a software program whose development can be tracked by a project management system 123 and whose source code 103A can be managed by a source code revision control system 105. Source code 103A is a collection of statements or declarations written in some human-readable computer programming language, most often used by programmers to specify the actions to be performed by a computer. A project can have a number of tasks. A task is a reasonably atomic action item in the course of a project (e.g., software project), such as a task to modify the source code 103A to fix a feature in the source code 103A. Each task can be assigned a task identifier and the tasks in a project may be assigned to one or more users 101B,C. A project management system 123 can track the status of the tasks for a software project. Examples of a project management system 123 can include, and are not limited to, Trac, Basecamp®, etc. A user 101B,C can work on different projects and a project can have one or more users 101B,C.

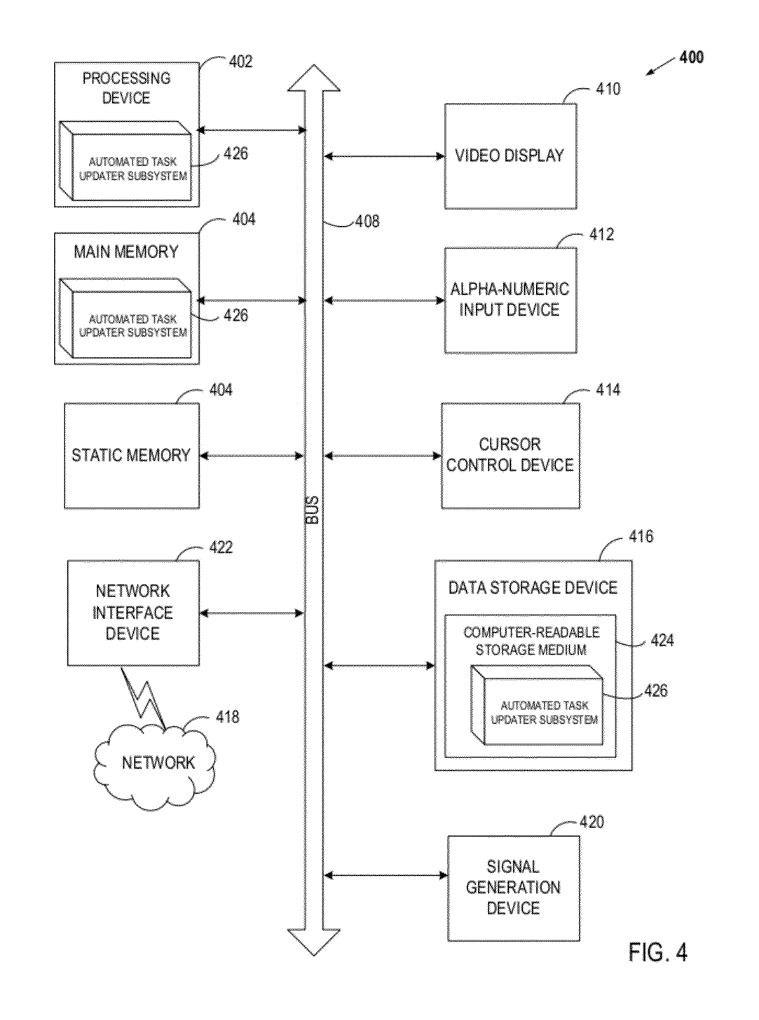

A project management system 123 can be hosted by any type of computing device including server computers, gateway computers, desktop computers, laptop computers, hand-held computers or similar computing device. An exemplary computing device is described in greater detail below in conjunction with FIG. 4. In one example, the project management system 123 can be a web application hosted by a web server 120 and accessible to a user 101B,C via a browser 113 hosted by a client 150. A web-based project management system 123 can be maintained by a third party.

Users 101B,C can use a source code revision control system 105 to change the source code 103, for example, to accomplish a task. A source code revision control system 105 is a system to implement source code revisions. Examples of source code revision control systems 105 can include, and are not limited to, CVS (Concurrent Versions System), Subversion® (SVN), GIT, and Mercurial. A source code revision control system 105 can be hosted by any type of computing device including server computers, gateway computers, client computers, desktop computers, laptop computers, hand-held computers or similar computing device. In one example, the source code revision control system (e.g., source code revision control system 105B) can be a web application hosted by a web server 180 and accessible to a user 101B,C via a browser 113 hosted by a client 150B.

A central server 180 can host a source code revision control system 105 and the source code 103A for a project. Client machines 150 can clone the source code 103A hosted by the central server 180, and users 101B,C can make changes to the local copies of the source code 103B,C and can push (provide) the changes to the source code revision control system 105. When a user 101B,C is ready to implement a source code revision, the user 101B,C inputs a new revision into the source code revision control system 105, and the source code revision control system 105 performs a commit operation. A ‘commit’ and/or ‘committing changes’ is a process by which a user 101B,C triggers the source code revision control system 105 to record the changes made to the software source code 103A. For each instance when a user 101B,C pushes a change to the source code 103A on the central server 180, the source code revision control system 105 logs data into a commit log 109. A commit log 109 can contain data provided by a user 101B,C that describes a certain change that is committed to a source code revision control system 105 by a user 101B,C. The commit log 109 can include a time stamp, a project identifier that specifies the project to which the commit log corresponds, task identifiers, and new task status data 110 for the tasks. There is a commit log 109 for each instance a user 101B,C executes a commit. A commit log 109 can be stored in a data store 107 that is coupled to the source code revision control system 105.

The project management system 123 can be configured with the location (e.g., pathname) of the source code 103A to be managed and the type of source code revision control system 105 that is being used (e.g., CVS, SVN, GIT, and Mercurial). A user 101B,C can access the web-based project management system 123 via a browser 113 and provide configuration data to set up one or more projects to be managed. The project management system 123 can create and maintain project management data 131 for various projects in a project management data store 130 that is coupled to the project management system 123. The project management data 131 can include current task status data 132 for each task in a project.

For example, a project management system 123 (e.g., Trac) manages a project pertaining to source code 103A. The project team may include users 101B,C. User 101B can specify to the project management system 123 that the source code revision control system 105 is an instance of GIT and provide the location of the GIT source code 103A. The Trac project management system 123 creates and maintains project management data 131 for the project for the GIT source code 103A in the project management data store 130. The project management data 131 can include, for example, the current task status data 132 (task state) for each task in the project. There may be one hundred tasks for the project and current task status data 132 for each of the one hundred tasks. For instance, the project management data store 130 stores data 131 for a project, that includes a task, Task#21 that has current task status data 132 “Opened”.

When user 101B, which is assigned to Task#21, changes a local copy of the GIT source code 103B that affects Task#21, client 150B provides the change to the source code revision control system 105 and the source code revision control system 105 generates a commit log 109 that includes new task status data 110 for Task#21, for example, “Implemented fix for XYZ feature. Resolved Task#21.” Typically, when a user 101B,C commits a change to the source code revision control system 105, the user 101B,C has to manually change the current task status data 132 in the project management data store 130 to reflect the change that was recorded in a commit log 109 by the source code revision control system 105. For example, traditionally, a user 101B,C has to access the project management system 123 and manually change the current task status data 132 for Task#21 from “Opened” to “Resolved.”

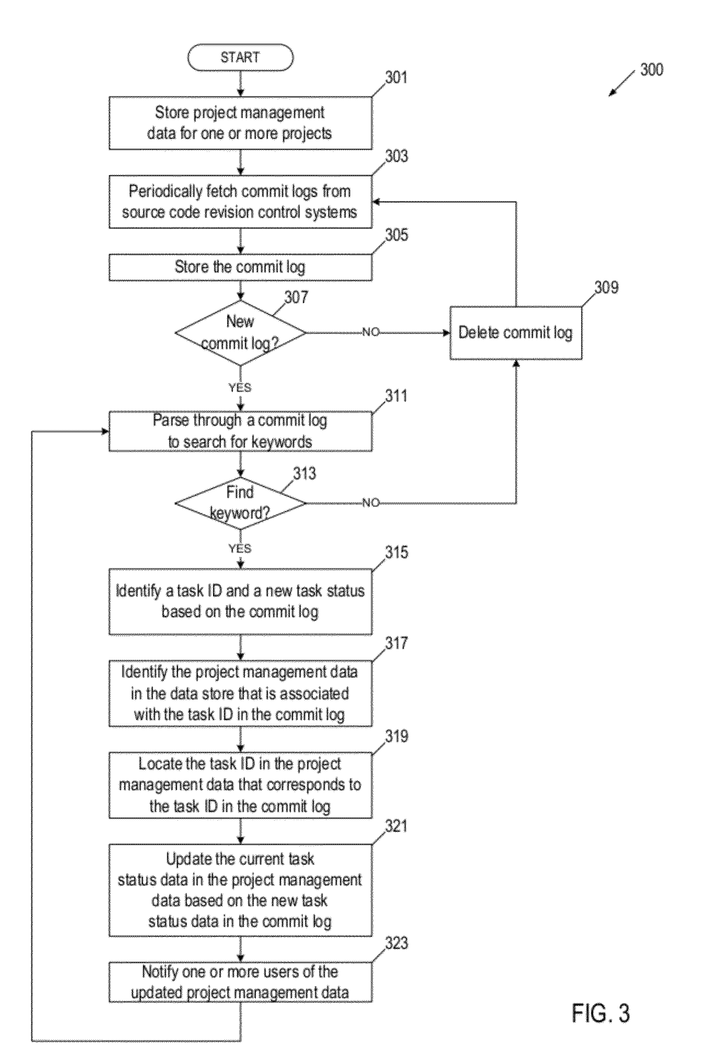

Embodiments of the project management system 123 include an automated task updater subsystem 125 to automatically modify the current task status data 132 in a project management system 123 via keywords in source code revision control 105 commit logs 109. The automated task updater subsystem 125 can periodically fetch commit logs 109 from one or more source code revision control systems 105 and use the new task status data 110 in the commit logs 109 to automatically update the corresponding current task status data 132 in the project management data 131. One embodiment of a method for automatically modifying task status in a project management system via keywords in source code revision control commit logs is described in greater detail below in conjunction with FIG. 3.

A data store 107,130 can be a persistent storage unit. A persistent storage unit can be a local storage unit or a remote storage unit. Persistent storage units can be a magnetic storage unit, optical storage unit, solid state storage unit, electronic storage units (main memory), or similar storage unit. Persistent storage units can be a monolithic device or a distributed set of devices. A ‘set’, as used herein, refers to any positive whole number of items.

In one embodiment, the project management system 123 and the source code revision control system 105 can be hosted by the same computing device including server computers, gateway computers, client computers, desktop computers, laptop computers, hand-held computers or similar computing device. In another embodiment, the project management system 123 and the source code revision control system 105 can be hosted by the separate computing devices including server computers, gateway computers, client computers, desktop computers, laptop computers, hand-held computers or similar computing device.

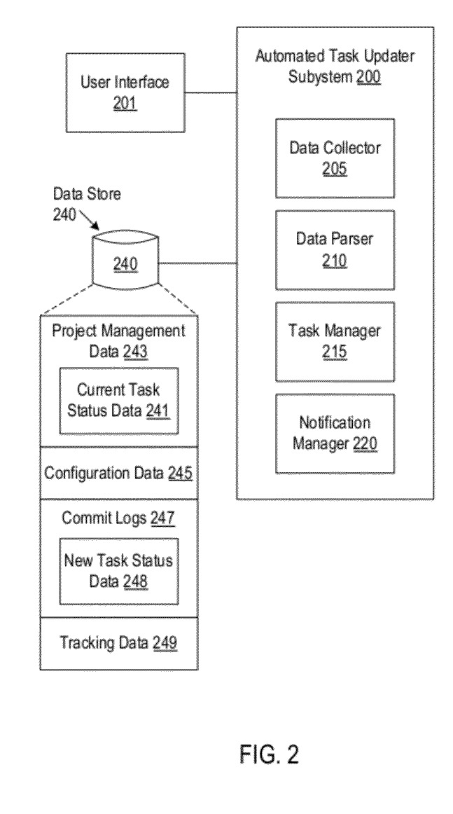

FIG. 2 is a block diagram of one embodiment of an automated task updater subsystem 200 for automatically modifying task status in a project management system via keywords in source code revision control commit logs. The automated task updater subsystem 200 can be the same as the automated task updater subsystem 125 in a project management system 123 hosted by a server 120 of FIG. 1.

A project management system uses a tasking system, where the work on a specific project is divided into one or more atomic tasks. A task can have one of many states (statuses). Table 1 illustrates exemplary task states. The example task states are not limited to those illustrated in Table 1.

TABLE 1

| Task State | Description |
|---|---|
| NEW (Unassigned) | A user requests a task to be done on a specific |
| | project. In a NEW state, the task may not have |
| | any user assigned to work on it. |
| OPENED/ASSIGNED | A user is assigned to a task or assigns a task |
| | to himself/herself, and is working on such a task. |
| STALLED | The work on a specific task is stopped for an |
| | indefinite/definite period of time due to some |
| | known/unknown reasons. |
| CLOSED/RESOLVED | A task is completed, and no more work needs to |
| | be done on the task. |

The project management data 243 for one or more projects can be stored in a data store 240 that is coupled to the automated task updater subsystem 200. The project management data 243 can include a project identifier for each project and can include the current task status data 241 (task state) for each task in a project. For example, there may be one hundred tasks for the project and current task status data 241 for each of the one hundred tasks.

A project management system can include an automated task updater subsystem 200 to automatically update the current task status data 241 for projects being managed by the project management system using commit logs that are generated by a source code revision control system. The automated task updater subsystem 200 can include a data collector 205, a data parser 210, a task manager 215, and a notification manager 220.

The data collector 205 can identify commit logs from one or more source code revision control systems, obtain the commit logs, and store the commit logs 247 in the data store 240 that is coupled to the automated task updater subsystem 200, according to one embodiment of the invention. In another embodiment, the data collector 205 can store the commit logs 247 in a cache. A commit log 247 can contain data provided by a user that describes a certain change that is committed to a source code revision control system. The commit log can include a time stamp, a project identifier that specifies the project for which the commit log corresponds to, task identifiers, and new task status data 248 for the tasks. The new task status data 248 in a commit log 247 specifies a change in status of a task.

The data collector 205 can be configured with the location of one or more source code revision control systems to extract the commit log (s) 247 from the source code revision control system(s). Configuration data 245 can be stored in the data store 240 specifying the location of the source code revision systems. Examples of configuration data 245 can include, and are not limited to, the type of source code revision control system that is being used for a particular project, location identifiers of one or more source code revision systems, collection parameters specifying time periods for when to collect the commit logs, collection parameters specifying the types of keywords to search for in a commit log, output parameters for generating reports and sending notifications, etc. Examples of a location identifier of a source code revision control system, can include, and are not limited to, the directory location of the source code revision control system, a URL on the Internet of the source code revision control system, etc. The configuration data 245 can be user-defined. For example, a user, such as a project manager or project team member, can provide the configuration data 245 via a user interface 201 (e.g., command line interface, web interface, etc.). For instance, the project manager can use a command line interface to enter a command and location identifier, such as ‘repository add <repos><dir>[type]’ for the source code revision control system, to add a particular source code revision control system as a source repository to the automated task updater subsystem 200. The configuration data 245 can be stored in a file in the data store 240 and is accessible by the data collector 205.

The data collector 205 can collect the commits logs 247 periodically. The configuration data 245 can include a collection parameter specifying a time period (e.g., once a minute, once an hour, once at 5:00 o'clock in the afternoon, etc.) for when the data collector 205 is to obtain the commit logs 247 from the source code revision control systems. The collection parameter can be user-defined. For example, a project manager and/or project team member, can provide the collection parameter via a user interface 201 specifying that the data collector 205 is to extract the commit logs once every half hour starting at 8:00 a.m. until 5:00 p.m., and once every three hours from 5:30 p.m. until 7:30 a.m. The specified time and/or time period can correspond to a specific project. In another example, the specified time and/or time period can correspond to a specific source code revision control system.

The data parser 210 can examine a commit log 247 that is stored in the data store 240 (or cache) and determine whether the commit log 247 is a new commit log. A new commit log is a commit log not yet parsed by the data parser 210. The data parser 210 can store a time associated with a commit log that was last searched by the data parser 210 in the data store 240 as part of tracking data 249 for a project. The data parser 210 can compare the time stamp of a commit log recently fetched by the data collector 205 with the time stamp in the tracking data 249. The data parser 210 can continuously update the tracking data 249 to reflect the most recently parsed commit log for a project.

The data parser 210 can parse new commit logs (e.g., commit logs that have a time stamp that follows the time stamp in the tracking data 249) and search for keywords. A keyword can be a characteristic of a task and/or a combination of task characteristics. The keywords can be user-defined. Examples of keywords can include, and are not limited to, task identifiers, tasks statuses (task states), etc. The data parser 210 can be configured via the configuration data 245 to search for a word, a task identifier, and/or a combination of both.

When the data parser 210 finds a keyword in a commit log, the data parser 210 identifies a task identifier and/or new task status data in the commit log that corresponds to the located keyword, according to one embodiment of the invention. For example, a commit log contains an entry

Implemented fix for XYZ feature. Opened Task#15 and Resolved Task#21.

The data parser 210 may be configured to search for keywords that are task statuses. The data parser 210 finds the keyword ‘Opened’ in the commit log and determines that ‘Task#15’ corresponds to the keyword ‘Opened’.

The task manager 215 can use the data located by the data parser 210, such as ‘Opened’ and ‘Task#15’, to update the current task status data 241 in the project management data 243 for the corresponding project in the data store 240. A commit log 247 can include a project identifier that specifies the project to which the commit log corresponds. The task manager 215 can use the project identifier to identify the project management data 243 in the data store 240 that is associated with the task identifier in the commit log. The task manager 215 can search the corresponding project management data 243 for a task identifier that corresponds (e.g., matches) to the task identifier in the commit log 247 and update the current task status data 241 in the project management data 243 based on the new task status data 248 in the commit log 247. For example, the task manager 215 searches for ‘Task#15’ in the project management data 243. The current task status data 241 in the project management data 243 for Task#15 may be ‘NEW’ and the task manager 215 changes ‘NEW’ to ‘OPENED’ as indicated by the new task status data 248 in the commit log 247 (e.g., ‘Opened Task#15’).

The notification manager 220 can notify one or more users of the updated project management data 247. Examples of notifications can include, and are not limited to, messages communicated via a network (e.g., email messages, text messages, instant messages, social network messages, etc.), visual/sound alarm indicators on a client device (e.g., client machine 150 in FIG. 1), etc.

The data parser 210 can periodically purge the commit logs 247 from the data store 240, according to one embodiment of the invention. For example, the data parser 210 can remove commit logs 247 that are not new. In another example, the data parser 210 can delete a commit log after the task manager 210 updates the project management data 243. In another embodiment, the data parser 210 can periodically clear a cache that stores the commit logs 247.

FIG. 3 is a flow diagram of an embodiment of a method 300 for automatically modifying task status in a project management system via keywords in source code revision control commit logs. Method 300 can be performed by processing logic that can comprise hardware (e.g., circuitry, dedicated logic, programmable logic, microcode, etc.), software (e.g., instructions run on a processing device), or a combination thereof. In one embodiment, method 300 is performed by the automated task updater subsystem 125 hosted by a server 120 of FIG. 1.

In one embodiment, the method 300 starts with the automated task updater subsystem storing and maintaining project management data for one or more projects in a project management data store that is coupled to the automated task updater subsystem. The project management data store stores tasks for a project and corresponding current task status data for each task in the project. At block 303, the automated task updater subsystem fetches commit logs from one or more source code revision control systems. The automated task updater subsystem can manage a number of different projects. These projects may be using different source code revision control systems. For example, users for one project (e.g., Project A) may use a source code revision control system (e.g., GIT) that is different from a source code revision control system (e.g., Mercurial) that is being used by users for a different project (e.g., Project B).

The automated task updater subsystem can obtain the commit logs from source code revision control systems periodically. A source code revision control system is a system to implement source code revisions. A source code revision control system can manage/track revisions/versions in source code of a software program. When a user is ready to implement a source code revision, the user inputs a new revision into the source code revision control system, and the source code revision control system performs a commit operation and generates a commit log for the commit operation. The commit log can include a time stamp, a project identifier that specifies the project to which the commit log corresponds, task identifiers, and new task status data for the tasks. The automated task updater subsystem can determine when to collect the commit logs based on configuration data that specifies a time and/or a time period. (e.g., once a minute, once an hour, once at 5:00 o'clock in the afternoon, etc.). For example, the automated task updater subsystem can extract the commit logs once every half hour starting at 8:00 a.m. until 5:00 p.m., and once every 3 hours from 5:30 p.m. until 7:30 a.m. The specified time and/or time period can correspond to a specific project. In another example, the specified time and/or time period can correspond to a specific source code revision control system. The configuration data can be user-defined.

At block 305, the automated task updater subsystem can store the commit logs in the project management data store, according to one embodiment of the invention. In another embodiment, the automated task updater subsystem stores the commit logs in a cache. At block 307, the automated task updater subsystem determines whether a fetched commit log is new. A commit log includes a time stamp indicating, for example, a time when a user committed a change to a source code revision control system. The automated task updater subsystem can store a time associated with a commit log that was last searched by the automated task updater subsystem in the data store as part of tracking data for a project. The automated task updater subsystem compares the time stamp of the commit log fetched at block 303 with the time stamp in the tracking data. A time stamp that precedes the time stamp in the tracking data indicates that the commit log fetched at block 303 is not a new commit log. A time stamp that succeeds (follows) the time stamp in the tracking data indicates that the commit log fetched at block 303 is a new commit log.

If the commit log is not a new commit log (block 307), the automated task updater subsystem deletes the commit log at block 309, according to one embodiment of the invention. The automated task updater subsystem returns to block 303 to continue fetching commit logs from source code revision control systems. If the commit log is a new commit log (block 307), the automated task updater subsystem parses the commit log to locate at least one keyword in the commit log to identify a change in status of at least one task at block 311. A keyword can be a characteristic of a task. Examples of keywords can include, and are not limited to, task identifiers, task status (task states), etc. A task status is one of many states that a task could be in. Examples of task statuses can include, and are not limited to, ‘NEW’, ‘OPENED’, ‘STALLED’, ‘RESOLVED/CLOSED’, etc. For instance, the automated task updater subsystem searches the commit log for keywords and finds ‘Close Task#12’ in a commit log. In another example, the automated task updater subsystem finds ‘Task 1233, RESOLVED’. The automated task updater subsystem can access configuration data that identifies the keywords to search for. The data can be stored in a configuration file in the project management data store. The configuration data can be user defined.

At block 313, the automated task updater subsystem determines whether there is a keyword in the commit log. If the automated task updater subsystem does not find a keyword in the commit log (block 313), the automated task updater subsystem deletes the commit log at block 309, according to one embodiment of the invention. The automated task updater subsystem returns to block 303 to continue fetching commit logs from source code revision control systems. If the automated task updater subsystem finds a keyword in the commit log (block 313), the automated task updater subsystem identifies a task identifier and/or a new task status based on the commit log at block 315. The automated task updater subsystem can continue to parse the data near (e.g., adjacent to, within a user-defined range of) the located keyword to identify the task identifier and/or new task status that corresponds to the keyword.

For example, a commit log contains an entry

Implemented fix for XYZ feature. Opened Task#15 and Resolved Task#21.

In this example, the automated task updater subsystem is configured to search for keywords that are task statuses. The automated task updater subsystem first finds the keyword ‘Opened’ in the commit log. At block 315, the automated task updater subsystem continues to parse the data near the keyword ‘Opened’ and determines that ‘Task#15’ corresponds to the keyword ‘Opened’. In another example, the automated task updater subsystem is configured to search for keywords that are task identifiers. The automated task updater subsystem first finds the keyword ‘Task#15’ in the commit log. At block 315, the automated task updater subsystem continues to parse the data near the keyword ‘Task#15’ and determines that ‘Opened’ corresponds to the keyword ‘Task#15’.

In another embodiment, the automated task updater subsystem is configured to search for keywords that are a combination of task identifiers and new task statuses, and the automated task updater subsystem can skip the operation performed at block 315. For example, the automated task updater subsystem finds the keyword ‘Opened Task#15’ in the commit log and continues to block 317.

At block 317, the automated task updater subsystem identifies the project management data in the project management data store that is associated with the task identifier in the commit log. The commit log can include a project identifier that specifies the project to which the commit log corresponds. The automated task updater subsystem can use the project identifier in the commit log to locate the project management data in the data store for the project that is identified in the commit log.

At block 319, the automated task updater subsystem searches the identified project management data for a task identifier that corresponds (e.g., matches) to the task identifier in the commit log and locates the corresponding task identifier in the project management data. For example, the automated task updater subsystem searches for Task#15 in the project management data and locates Task#15 in the project management data. In one embodiment, the task identifiers in the commit log may not be identical (e.g., may have a different format) to the task identifiers in the project management data and the project management tool can store data (e.g., an index) that specifies which task identifier in the project management data corresponds to the task identifier in the commit log. For example, a commit log contains ‘Open Task#15’ and the corresponding task identifier in the project management data is ‘Task 00015’. The project management data can store an index correlating Task #15 in the commit log to Task 00015 in the project management data.

At block 321, the automated task updater subsystem updates the current task status data in the project management data store to reflect the change in status of at least one task. For example, the current task status data in the project management data store for Task#15 is ‘NEW’ and the automated task updater subsystem changes ‘NEW’ to ‘OPENED’ as indicated by the new task status data in the commit log (e.g., ‘Opened Task#15’).

In one embodiment, at block 323, the automated task updater subsystem notifies one or more users of the updated project management data. A project management tool may have an option to configure notification parameters (e.g., email address, text message address, pager number, etc.) for users. The automated task updater can send a notification to one or more users, such as a project manager and project team members, indicating a change in status for certain tasks of a project. Examples of notifications can include, and are not limited to, messages communicated over a network (e.g., email messages, text messages, instant messages, social network messages, etc.), visual/sound alarm indicators on a client device (e.g., client machine 150 in FIG. 1), etc.

The automated task updater subsystem returns to block 311 to continue to parse through the commit log to search for and locate keywords. In the above example, the commit log includes ‘Implemented fix for XYZ feature. Opened Task#15 and Resolved Task#21’. The automated task updater subsystem returns to block 311 and locates ‘Resolved’ in the commit log. The automated task updater subsystem identifies that ‘Task#21’ corresponds the keyword ‘Resolved’ and updates the current task status data in the project management data for Task#21. For example, the current task status data in the project management data for Task#21 is ‘STALLED’ and the automated task updater subsystem changes ‘STALLED’ to ‘RESOLVED’ as indicated by the new task status data in the commit log (e.g., ‘Resolved Task#21’).

FIG. 4 is a diagram of one embodiment of a computer system for automatically modifying task status in a project management system via keywords in source code revision control commit logs. Within the computer system 400 is a set of instructions for causing the machine to perform any one or more of the methodologies discussed herein. In alternative embodiments, the machine may be connected (e.g., networked) to other machines in a LAN, an intranet, an extranet, or the Internet. The machine can operate in the capacity of a server or a client machine (e.g., a client computer executing the browser and the server computer executing the automated task delegation and project management) in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 400 includes a processing device 402, a main memory 404 (e.g., read-only memory (ROM), flash memory, dynamic random access memory (DRAM) such as synchronous DRAM (SDRAM) or DRAM (RDRAM), etc.), a static memory 406 (e.g., flash memory, static random access memory (SRAM), etc.), and a secondary memory 416 (e.g., a data storage device in the form of a drive unit, which may include fixed or removable computer-readable storage medium), which communicate with each other via a bus 408.

Processing device 402 represents one or more general-purpose processing devices such as a microprocessor, central processing unit, or the like. More particularly, the processing device 402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. Processing device 402 is configured to execute the automated task updater subsystem 426 for performing the operations and steps discussed herein.

The computer system 400 may further include a network interface device 422. The computer system 400 also may include a video display unit 410 (e.g., a liquid crystal display (LCD) or a cathode ray tube (CRT)) connected to the computer system through a graphics port and graphics chipset, an alphanumeric input device 412 (e.g., a keyboard), a cursor control device 414 (e.g., a mouse), and a signal generation device 420 (e.g., a speaker).

The secondary memory 416 may include a machine-readable storage medium (or more specifically a computer-readable storage medium) 424 on which is stored one or more sets of instructions (e.g., the automated task updater subsystem 426) embodying any one or more of the methodologies or functions described herein. The automated task updater subsystem 426 may also reside, completely or at least partially, within the main memory 404 and/or within the processing device 402 during execution thereof by the computer system 400, the main memory 404 and the processing device 402 also constituting machine-readable storage media. The automated task updater subsystem 426 may further be transmitted or received over a network 418 via the network interface device 422.

The computer-readable storage medium 424 may also be used to store the automated task updater subsystem 426 persistently. While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The automated task updater subsystem 426, components and other features described herein (for example in relation to FIG. 1) can be implemented as discrete hardware components or integrated in the functionality of hardware components such as ASICS, FPGAs, DSPs or similar devices. In addition, the automated task updater subsystem 426 can be implemented as firmware or functional circuitry within hardware devices. Further, the automated task updater subsystem 426 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “storing,” “obtaining,” “searching,” “locating,” “updating,” “determining,” “comparing,” “notifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus can be specially constructed for the required purposes, or it can comprise a general purpose computer system specifically programmed by a computer program stored in the computer system. Such a computer program can be stored in a computer-readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems can be used with programs in accordance with the teachings herein, or it may prove convenient to construct a more specialized apparatus to perform the method steps. The structure for a variety of these systems will appear from the description below. In addition, embodiments of the present invention are not described with reference to any particular programming language. It will be appreciated that a variety of programming languages can be used to implement the teachings of embodiments of the invention as described herein.

A computer-readable storage medium can include any mechanism for storing information in a form readable by a machine (e.g., a computer), but is not limited to, optical disks, Compact Disc, Read-Only Memory (CD-ROMs), and magneto-optical disks, Read-Only Memory (ROMs), Random Access Memory (RAM), Erasable Programmable Read-Only memory (EPROM), Electrically Erasable Programmable Read-Only Memory (EEPROM), magnetic or optical cards, flash memory, or the like.

Thus, a method and apparatus for automatically generating code for automatically modifying task status in a project management system via keywords in source code revision control commit logs. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method, implemented by a server computing system programmed to perform the following, comprising:
maintaining, by the server computing system, a project management data store that is coupled to the server computing system, wherein the project management data store comprises tasks of a project and corresponding current task status data for the tasks;
obtaining a commit log from a source code revision control system, wherein the commit log comprises new task status data for at least one task of the project;
locating at least one keyword in the commit log to identify a change in status of at least one task; and
updating the current task status data in the project management data store to reflect the change in the status of the at least one task.

2. The method of claim 1, wherein locating at least one keyword in the commit log comprises:
determining whether the commit log is a new commit log; and
searching the commit log for at least one keyword based on a determination that the commit log is a new commit log.

3. The method of claim 2, wherein determining whether the commit log is a new commit log comprises:
comparing a time stamp of the commit log to a time stamp of a commit log that was last searched; and
searching the commit log for at least one keyword based on a determination that the time of the stamp of the commit log is after the time of the time stamp of the commit log that was last searched.

4. The method of claim 1, wherein updating the current task status data in the project management data store comprises:
identifying data in the project management data store that is associated with the task identifier in the commit log;
locating a task identifier in the identified data that is associated with the task identifier in the commit log; and
updating the current task status data in the identified data based on the new task status data in the commit log.

5. The method of claim 1, wherein the keywords comprise at least one of task identifiers and tasks states.

6. The method of claim 1, wherein obtaining a commit log from the source code revision control system comprises:
obtaining a commit log from the source code revision control system periodically.

7. The method of claim 1, further comprising:
notifying one or more users of the updated project management data for the project.

8. A system comprising:
a project management data store to store project management data, wherein the project management data comprises tasks of a project and corresponding current task status data for the tasks; and
a processor coupled to the project management data store to obtain a commit log from a source code revision control system, wherein the commit log comprises new task status data for at least one task of the project, to locate at least one keyword in the commit log to identify a change in status of at least one task, and to update the current task status data in the project management data store that corresponds to the task identifier in the commit log to reflect the change in the status of the at least one task.

9. The system of claim 8, wherein to locate at least one keyword in the commit log comprises the processor:
to determine whether the commit log is a new commit log; and
to search the commit log for at least one keyword based on a determination that the commit log is a new commit log.

10. The system of claim 8, wherein to determine whether the commit log is a new commit log comprises the processor:
to compare a time stamp of the commit log to a time stamp of a commit log that was last searched; and
to search the commit log for at least one keyword based on a determination that the time of the stamp of the commit log is after the time of the time stamp of the commit log that was last searched.

11. The system of claim 8, wherein to update the current task status data in the project management data store comprises the processor:
to identify data in the project management data in the data store that is associated with the task identifier in the commit log;
to locate a task identifier in the identified data that is associated with the task identifier in the commit log; and
to update the current task status data in the identified data based on the new task status data in the commit log.

12. The system of claim 8, wherein the keywords comprise at least one of task identifiers and tasks states.

13. The system of claim 8, wherein to obtain a commit log from the source code revision control system comprises the processor:
to obtain a commit log from the source code revision control system periodically.

14. The system of claim 8, further comprising the processor:
to notify one or more users of the updated project management data for the project.

15. A non-transitory computer-readable storage medium including instructions that, when executed by a computer system, cause the computer system to perform a set of operations comprising:
maintaining a project management data store that is coupled to the computer system, wherein the project management data store comprises tasks of a project and corresponding current task status data for the tasks;
obtaining a commit log from a source code revision control system, wherein the commit log comprises new task status data for at least one task of the project;
locating at least one keyword in the commit log to identify a change in status of at least one task; and
updating the current task status data in the project management data store to reflect the change in the status of the at least one task.

16. The non-transitory computer-readable storage medium of claim 15, wherein locating at least one keyword in the commit log comprises:
determining whether the commit log is a new commit log; and
searching the commit log for at least one keyword based on a determination that the commit log is a new commit log.

17. The non-transitory computer-readable storage medium of claim 16, wherein determining whether the commit log is a new commit log comprises:
comparing a time stamp of the commit log to a time stamp of a commit log that was last searched; and
searching the commit log for at least one keyword based on a determination that the time of the stamp of the commit log is after the time of the time stamp of the commit log that was last searched.

18. The non-transitory computer-readable storage medium of claim 15, wherein updating the current task status data in the project management data store comprises:
identifying data in the project management data store that is associated with the task identifier in the commit log;
locating a task identifier in the identified data that is associated with the task identifier in the commit log; and
updating the current task status data in the identified data based on the new task status data in the commit log.

19. The non-transitory computer-readable storage medium of claim 15, wherein the keywords comprise at least one of task identifiers and tasks states.

20. The method of claim 1, further comprising:
notifying one or more users of the updated project management data for the project.
